(19) United States
(12) Patent Application Publication
(10) Pub. No.: US 2011/0249358 A1
(43) Pub. Date: Oct. 13, 2011

(54) APPARATUS AND METHOD OF DETECTING A DEFECTIVE SECTOR IN A DISK DRIVE

(75) Inventors: Ji-young LEE, Hwaseong-si (KR); Man-sik Sim, Hwaseong-si (KR)

(73) Assignee: Samsung Electronics Co., Ltd, Suwon-si (KR)

(21) Appl. No.: 13/085,657

(22) Filed: Apr. 13, 2011

(30) Foreign Application Priority Data
Apr. 13, 2010 (KR) 10-2010-0033899

(51) Int. Cl. G11B 5/02

(52) U.S. Cl. 360/55; G9B/5.026

(57) ABSTRACT

A method and apparatus to detect a defective sector include features of determining a first error value by counting the number of error symbols in first data read from a sector by using a head in an on-track state, and reading second data from the sector by off-tracking the head in a positive direction and third data from the sector by off-tracking the head in a negative direction in response to the first error value being equal to or greater than a first threshold value. Additionally, a second error value is determined based on the number of error symbols in the read second data and a third error value is determined based on the number of error symbols in the read third data. Accordingly, the sector is determined to have a defect by comparing an average of the second and third error values to a second threshold value.

### CROSS-REFERENCE TO RELATED APPLICATIONS

This application claims the benefit of priority under 35 U.S.C. §119(a) from Korean Patent Application No, 10-2010-0033899, filed on Apr. 13, 2010, in the Korean Intellectual Property Office, the disclosure of which is incorporated herein in its entirety by reference.

### BACKGROUND

1. Field of the Invention

The general inventive concept relates to a disk drive, and more particularly, to a method of detecting a defective sector from among sectors of a disk drive.

2. Description of the Related Art

Hard disk drives traditionally include one or more disks and at least one head to write and/or read data to and/or from the disk. The disks include at least one track having at least one sector to store data. The head generally operates in an on-track state, which positions the head at a nominal center of the track such that the head can write and/or read data to and/or from a sector of the track.

During operation of the hard disk drive, however, the head may inadvertently deviate from the nominal center of the track, thereby causing data to be erroneously written to an off-track region of the disk. Thereafter, a head may encounter an error when attempting to read data from a track that includes data written in the off-track region. Accordingly, a sector adjacent to the erroneous off-track data may be rendered defective.

Conventional methods of detecting a defective sector have been developed that detect a defective sector from among sectors of a disk drive while the head is positioned in the on-track state. Conventionally, data is read from a predetermined sector of a disk while the head is positioned in an on-track state, so as to detect whether the predetermined sector has a defect. However, the disk may also contain additional errors that may be detected while the head is positioned in the on-track state. As a result, it is difficult to distinguish a defective sector from various other errors existing in the disk. Additionally, the head may be inadvertently positioned during a write process such that data is not fully written to the sector. However, a head positioned in the on-track state may not fully detect a defective sector where only a partial amount of data is written to the sector.

### SUMMARY

According to an feature of the general inventive concept, there is provided a method of detecting a defective sector, the method including determining a first error value by counting the number of error symbols in first data read from a sector by using a head in an on-track state; reading second data from the sector by off-tracking the head in a positive direction, and reading third data from the sector by off-tracking the head in a negative direction, if the first error value is equal to or greater than a first threshold value; determining a second error value based on the number of error symbols in the read second data; determining a third error value based on the number of error symbols in the read third data; and determining whether the sector has a defect, by comparing an average of the second and third error values to a second threshold value.

Additional aspects and utilities of the present general inventive concept will be set forth in part in the description which follows and, in part, will be obvious from the description, or may be learned by practice of the present general inventive concept.

The determining of whether the sector has a defect may include comparing the second and third error values to a third threshold value, if the average of the second and third error values is equal to or greater than the second threshold value; and determining that the sector has a defect, if the second and third error values are equal to or greater than the third threshold value.

The method may further include determining that the sector has a defect, without performing the reading of the second and third data, the determining of the second error value, the determining of the third error value, and the determining of whether the sector has a defect, if the first error value is equal to or greater than a fourth threshold value greater than the first threshold value, and the reading of the second and third data may include reading second data from the sector by off-tracking the head in the positive direction, and reading third data from the sector by off-tracking the head in the negative direction, if the first error value is equal to or greater than the first threshold value, and is less than the fourth threshold value.

The reading of the second and third data may include repeatedly reading second data from the sector by off-tracking the head in the positive direction, and repeatedly reading third data from the sector by off-tracking the head in the negative direction, if the first error value is equal to or greater than the first threshold value, and is less than the fourth threshold value.

According to another feature of the general inventive concept, there is provided a method of detecting a defective sector, the method including repeatedly reading first data from a sector by using a head in an on-track state; determining a plurality of first error values by counting the number of error symbols in each piece of the read first data; reading second data from the sector by off-tracking the head in a positive direction, and reading third data from the sector by off-tracking the head in a negative direction, if the plurality of first error values are equal to or greater than a first threshold value; determining a second error value based on the number of error symbols in the read second data; determining a third error value based on the number of error symbols in the read third data; and determining whether the sector has a defect, by comparing an average of the second and third error values to a second threshold value.

The method may further include determining that the sector does not have a defect, if at least one of the plurality of first error values is less than the first threshold value.

The method may further include determining that the sector has a defect, without performing the reading of the second and third data, the determining of the second error value, the determining of the third error value, and the determining of whether the sector has a defect, if the plurality of first error values are equal to or greater than a fourth threshold value greater than the first threshold value, and the reading of the second and third data may include reading second data from the sector by off-tracking the head in the positive direction, and reading third data from the sector by off-tracking the head in the negative direction, if the plurality of first error values are equal to or greater than the first threshold value, and are less than the fourth threshold value.

In another feature of the general inventive concept, A hard disk drive to detect a defective sector in at least one disk included in the hard disk drive, comprising a head operable in an on-track state to read first data from a sector in the at least one disk and operable in an off-track state to off-track the head in a positive direction with respect to a center of the sector to read second data from the sector and to off-track the head in a negative direction with respect to the center of the sector to read third data from the sector, and a controller in electrical communication with the head and operable in an on-track mode to initiate the on-track state of the head and to determine a first error value by counting a number of error symbols in the first data and operable in an off-track mode to initiate the off-track state of the head in response to the first error value being equal to or greater than a first threshold value.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a structural schematic diagram of a hard disk drive according to an exemplary embodiment of the general inventive concept;

FIG. 2 is a block diagram of the hard disk drive illustrated in FIG. 1, according to an exemplary embodiment of the general inventive concept;

FIG. 3 is a flowchart of a method of detecting a defective sector, according to an exemplary embodiment of the general inventive concept;

FIG. 4 is a flowchart of a method of detecting a defective sector, according to another exemplary embodiment of the general inventive concept;

FIG. 5A is a diagram showing a state when data is recorded on a plurality of sectors;

FIG. 5B is a diagram showing another state when data is recorded on a plurality of sectors;

FIG. 6 is a flowchart of a method of detecting a defective sector, according to another exemplary embodiment of the general inventive concept; and

FIG. 7 is a flowchart of a method of detecting a defective sector, according to another exemplary embodiment of the general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

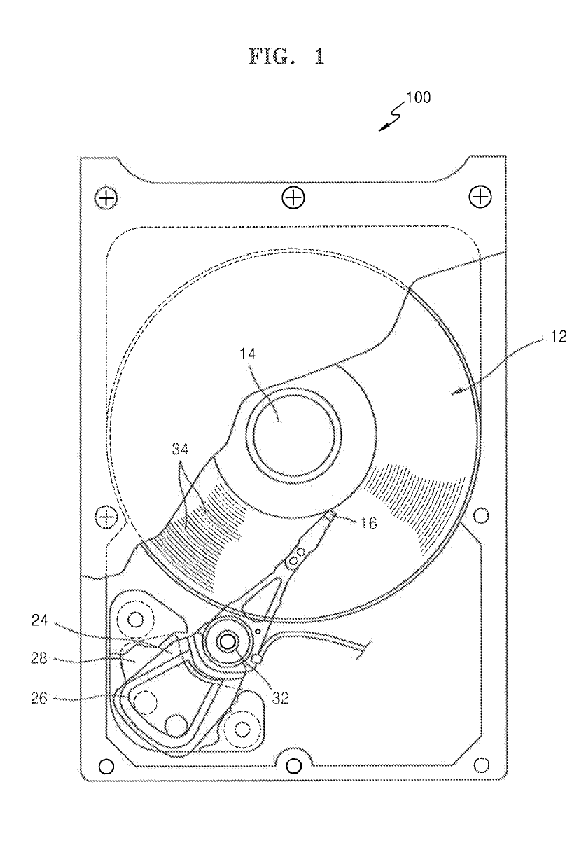

FIG. 1 is a structural schematic diagram of a hard disk drive 100 according to an exemplary embodiment of the general inventive concept.

Referring to FIG. 1, the hard disk drive 100 includes at least one disk 12 that is rotated by a spindle motor 14, and a converter (not shown) disposed adjacent to a surface of the disk 12.

The converter may read and/or record information from and/or to the disk 12 while the disk 12 rotates by sensing a magnetic field of or magnetizing the disk 12. Typically, the converter is coupled to the surface of the disk 12. Although a single converter is described above, it should be understood that the converter includes a writer to magnetize the disk 12 and a reader to sense a magnetic field of the disk 12. A reader is formed by using a magneto-resistive (MR) device.

The disk drive 100 may include a head support 20 having one end coupled to the arm 24 and an opposite end that supports a head 16. The head 16 generates an air bearing between the converter and the surface of the disk 12. The head 16 is integrated with a head stack assembly (HSA) 20. The HSA 20 is bonded to an actuator arm 24 that has a voice coil 26. voice coil 26 is disposed adjacent to a magnetic assembly 28. A current supplied to the voice coil 26 generates torque to rotate the actuator arm 24 about a bearing assembly 32. The rotation of the actuator arm 24 will move the converter across the surface of the disk 12. First and second stoppers 36, 38, are provided to limit the movement of the actuator arm 24 in the space 30 located between the stoppers 36, 38.

The disk 12 includes ring-shaped tracks 34 that may store data information. Each of the tracks 34 generally includes a plurality of sectors. Each of the sectors includes a data field and a servo field. The servo field records a preamble, servo address/index marks (SAM/SIM), gray codes, and burst signals. The converter moves across the surface of the disk 12 to read and/or record information from and/or to different tracks 34.

The hard disk drive 100 may operate in an on-track mode and an off-track mode, The on-track mode positions the converter, which includes the head 16, in an on-track state. Accordingly, the head 16 is positioned at a nominal center of a track 34 to write and/or read data to and from a sector of the track 34. The off-track mode positions the converter in an off-track state such that the head 16 is positioned in a positive off-track direction or a negative off-track direction with respect to the center of the track 34. For example, the positive off-track direction may be a direction extending toward the outer circumference of the disk 12 with respect to the center of the track, while the negative off-track direction may be a direction extending toward the center of the disk 12 with respect to the center of the track.

In the current exemplary embodiment, the head 16 includes a structure to generate an air bearing surface between the reader and the writer and the surface of the disk 12, and a heater (not shown) to heat the structure.

Although a hard disk drive 100 including one disk 12 is described above, it can be appreciated that the hard disk drive 100 may include a plurality of disks 12, and a plurality of heads 16 are mounted to correspond to surfaces of the disks 12. For example, if the hard disk drive 100 includes two disks 12, four heads 16 are mounted on the HSA 20. Each of the heads 16 may also include a heater.

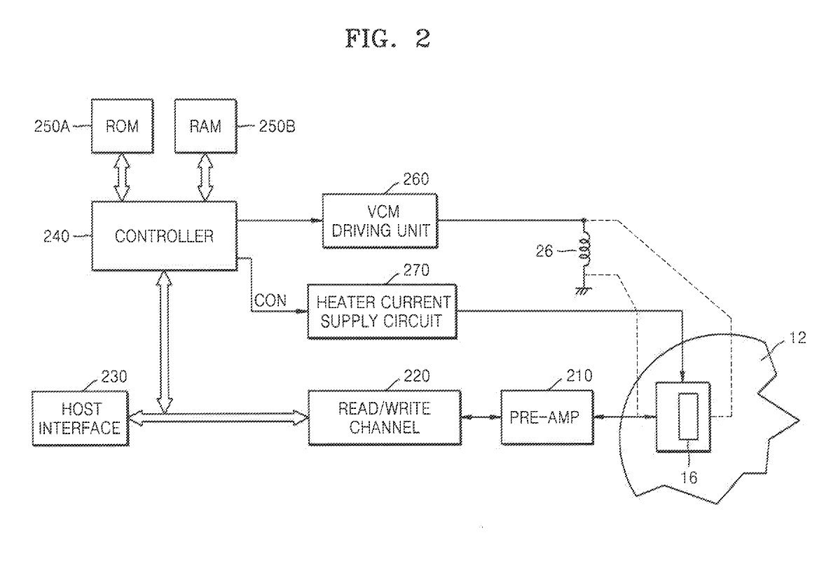

FIG. 2 is a block diagram of the hard disk drive 100 illustrated in FIG. 1, according to an exemplary embodiment of the general inventive concept.

Referring to FIG. 2, the hard disk drive 100 includes the disk 12, the head 16, a pre-amplifier 210, a read/write module 220, a host interface 230, a controller 240, read-only memory (ROM) 250A, random access memory (RAM) 250B, a VCM driving unit 260 and a heater current supply circuit 270.

The ROM 250A may store, for example, firmware and control information to control the hard disk drive 100. The RAM 250B may store information required to drive the hard disk drive 100, wherein the information is read from the ROM 250A or the disk 12 when the hard disk drive 100 is initially driven.

The controller 240 analyzes a command received from a host device (not shown) via the host interface 230, and performs a controlling operation corresponding to the analyzed result. For example, the controlling operation may include, but is not limited to, providing control signals to the VCM driving circuit 260 and the heater current supply circuit 270 in order to control motion of the head 16.

General operation of the hard disk drive 100 is as described below.

The controller 240 may operate in a data read mode and/or a data write mode. When operating in the data read mode, the pre-amplifier 210 pre-amplifies an electrical signal sensed from the disk 12 by the reader of the head 16. Then, the read/write module 220 amplifies the electrical signal pre-amplified by the pre-amplifier 210 to a predetermined level by using a gain controlled by an automatic gain control circuit (not shown). The gain level may be set according to preliminary manufacturer settings. The controller 240 further encodes the amplified electrical signal from an analog signal to a digital signal that is readable by the host device, converts the encoded electrical signal into stream data, and transmits the stream data to the host device via the host interface 230.

When the controller 240 operates in the write mode, the read/write module 220 converts data received from the host device via the host interface 230, into a binary data stream appropriate to record, and records a recording current pre-amplified by the pre-amplifier 210 on the disk 12 by using the writer of the head 16.

The read/write module 220 provides information required to control track seeking and track following to the controller 240 while reproducing data signals including, but not limited to, a preamble signal, Servo Address Mark/Servo Index Mark (SAM/SIM) signals, gray codes, and burst signals, which are recorded in a servo field of the disk 12.

Additionally, the controller 240 may perform a servo copying operation. When the servo copying operation is performed, the read/write module 220 provides information required to control track seeking and track following to the controller 240 while reproducing a reference servo pattern recorded on one of a plurality of disks 12 by using a reference head. Accordingly, the head 16 may be positioned with respect to a track 34 of the disk 12 to write data thereto.

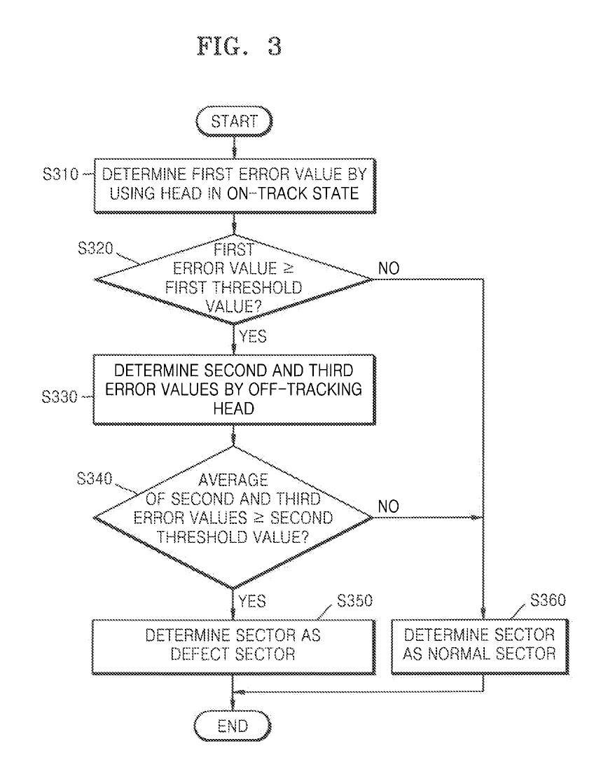

FIG. 3 is a flowchart of a method of detecting a defective sector, according to an exemplary embodiment of the general inventive concept.

Referring to FIG. 3, a head 16 of a hard disk drive 100 may be initially controlled to operate in the on-track state such that the head 16 is positioned at the center of a sector to detect whether a sector included in a track is defective. More specifically, first data may be read from the sector while the head 16 is positioned at the center of the track according to the on-track state. The controller 240 may analyze the first read data to determine whether any error symbols exist, and may calculate a total number of error symbols existing in the read first data to determine as a first error value (operation S310).

The determined first error value may be compared to a first threshold value (operation 5320). If the first error value is less than the first threshold value in operation S320, the sector may be determined as a normal sector having no defect (operation S360).

The first threshold value, more specifically, may be the largest value to determine that the sector does not have a defect from among a plurality of numbers of error symbols. For example, if the number of error symbols in data read from a predetermined sector when the head 16 operates in the on-track state is between 0 and 7, and if it is determined that the sector does not have a defect, the first threshold value may be 8. However, the first threshold value may vary if necessary, That is, the first threshold value may be reduced to increase accuracy or may be increased to increase capacity with an appropriate accuracy. Furthermore, the first threshold value may be determined with reference to a bit error rate of the sector.

Otherwise, if the first error value is equal to or greater than the first threshold value in operation S320, the off-track mode of the hard disk drive 100 may be initiated and the head 16 may be positioned in the off-track state such that second data may be read from the sector by off-tracking the head 16 in a positive direction. Additionally, the head 16 may be positioned in the negative off-track direction such that third data may be read from the sector by off-tracking the head 16 in a negative direction. For example, the second data may be read from the sector by off-tracking the head 16 in the positive direction by 15%, and the third data may be read from the sector by off-tracking the head 16 in the negative direction by 15%. Similar to the first read data, the read second data may include at least one error symbol, and the number of error symbols counted in the read second data may be determined as a second error value (operation S330). Also, the read third data may include at least one error symbol, and the number of error symbols counted in the read third data may be determined as a third error value (operation S330).

Alternatively, in operation S330, the second data may be repeatedly read from the sector by positioning the head 16 in the positive off-track direction, i.e., off-tracking the head 16 in the positive direction, and the third data may be repeatedly read from the sector by positioning the head 16 in the negative direction, Le., off-tracking the head 16 in the negative direction. Each portion of the read second data may include at least one error symbol, and the number of error symbols may be counted in each piece of the read second data, The controller 240 may then calculate an average of the numbers of error symbols counted in the second data to determine the second error value (operation S330). Similarly, each portion of the read third data may include at least one error symbol, and the number of error symbols may be counted in each portion of the read third data, An average of the numbers of error symbols counted in the third data may be determined as the third error value (operation 3330).

When the second and third error values are determined, an average of the second and third error values may be compared to a second threshold value (operation S340). If the average of the second and third error values is equal to or greater than the second threshold value, the sector may be determined as a defective sector having a defect (operation S350). Otherwise, if the average of the second and third error values is less than the second threshold value, the sector may be determined as a normal sector having no defect (operation S360). The second threshold value may be greater than the first threshold value. For example, if the number of error symbols in data read from a predetermined sector by using the head 16 in the on-track state is equal to or greater than 16, and if it is determined that the sector has a defect, the second threshold value may be 16. However, like the first threshold value, the second threshold value may also vary if necessary. Furthermore, like the first threshold value, the second threshold value may also be determined with reference to a bit error rate of the sector.

Although not illustrated in FIG. 3, the method illustrated in FIG. 3 may further include comparing the first error value to a fourth threshold value, between operations S320 and S330. In more detail, if the first error value is equal to or greater than the fourth threshold value, the method may directly proceed to operation S350 so as to determine the sector as a defect sector having a defect, without performing operations S330 and S340. If the first error value is equal to or greater than the first threshold value, and is less than the fourth threshold value, operations S330 and S340 may be performed to determine whether the sector has a defect. That is, if it may not be determined that the sector does not have a defect because the first error value is equal to or greater than the first threshold value, and if it may not be definitely that the sector has a defect because the first error value is less than the fourth threshold value, operations S330 and S340 may be performed.

The fourth threshold value may be the smallest value to determine that the sector has a defect, from among a plurality of number of error symbols. For example, if it is determined that a predetermined sector has a defect when the number of error symbols in data read from the sector is equal to or greater than 13, the fourth threshold value may be 13. However, like the first threshold value, the fourth threshold value may also vary if necessary. Furthermore, like the first threshold value, the fourth threshold value may also be determined with reference to a bit error rate of the sector.

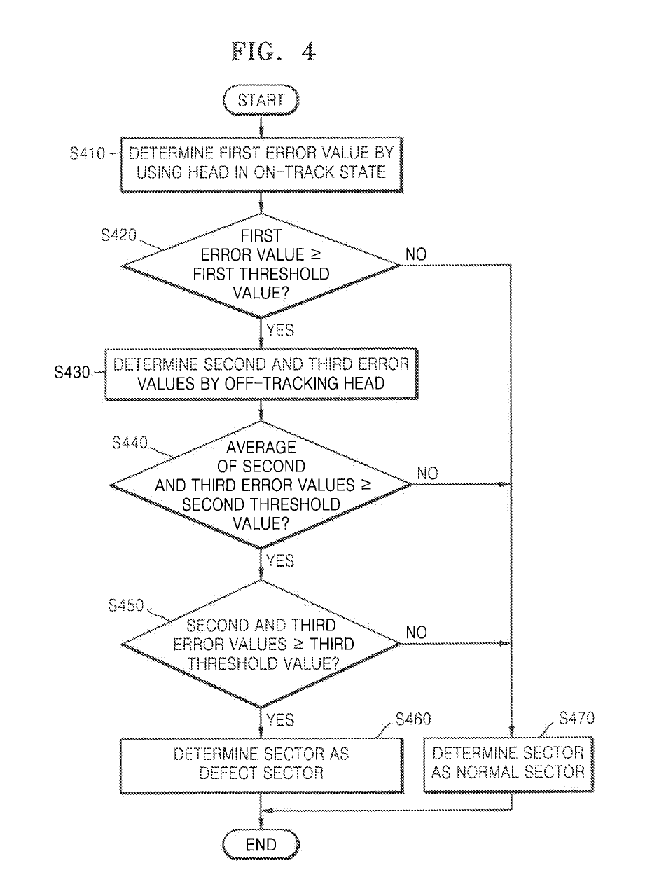

FIG. 4 is a flowchart of a method of detecting a defective sector, according to another exemplary embodiment of the general inventive concept.

Referring to FIG. 4, first data may be read from a sector to detect a defect, by using a head 16 in an on-track state. The read first data may include at least one error symbol, and the number of error symbols counted in the read first data may be determined as a first error value (operation S410).

The determined first error value may be compared to a first threshold value (operation S420). if the first error value is less than the first threshold value in operation S420, the sector may be determined as a normal sector having no defect (operation S470). The first threshold value is described above in detail in relation to FIG. 3, and thus a detailed description thereof will not be provided here.

Otherwise, if the first error value is equal to or greater than the first threshold value in operation S420, second data may be read from the sector by off-tracking the head 16 in a positive direction, and third data may be read from the sector by off-tracking the head 16 in a negative direction. The read second data may include at least one error symbol, and the number of error symbols counted in the read second data may be determined as a second error value (operation S430). Also, the read third data may include at least one error symbol, and the number of error symbols counted in the read third data may be determined as a third error value (operation S430).

Alternatively, in operation S430, the second data may be repeatedly read from the sector by off-tracking the head 16 in the positive direction, and the third data may be repeatedly read from the sector by off-tracking the head 16 in the negative direction. Each piece of the read second data may include at least one error symbol, and the number of error symbols may be counted in each piece of the read second data. An average of the number of error symbols counted in the second data may be determined as the second error value (operation S430). Also, each piece of the read third data may include at least one error symbol, and the number of error symbols may be counted in each piece of the read third data. An average of the number of error symbols counted in the third data may be determined as the third error value (operation S430).

Operations S410, S420, and S430 are similar to operations S310, S320 and S330 illustrated in FIG. 3, and thus detailed descriptions thereof will not be provided here.

When the second and third error values are determined, an average of the second and third error values may be compared to a second threshold value (operation S440). If the average of the second and third error values is less than the second threshold value, the sector may be determined as a normal sector having no defect (operation S470). The second threshold value is described above in detail in relation to FIG. 3, and thus a detailed description thereof will not be provided here.

If the average of the second and third error values is equal to or greater than the second threshold value, the second and third error values may be compared to a third threshold value (operation S450). If the second and third error values are equal to or greater than the third threshold value in operation S450, the sector may be determined as a defective sector having a defect (operation S460). If at least one of the second and third error values is less than the third threshold value in operation S450, the sector may be determined as a normal sector having no defect (operation S470).

Although not illustrated in FIG. 4, like the method illustrated in FIG. 3, the method illustrated in FIG. 4 may further include comparing the first error value to a fourth threshold value, between operations S420 and S430. In more detail, if the first error value is equal to or greater than the fourth threshold value, the method may proceed to operation S460 so as to determine the sector as a defective sector having a defect, without performing operations S430, S440, and S450. If the first error value is equal to or greater than the first threshold value, and is less than the fourth threshold value, operations S430, S440, and S450 may be performed to determine whether the sector has a defect. That is, if it may not be determined that the sector does not have a defect because the first error value is equal to or greater than the first threshold value, and if it may not be determined that the sector has a defect because the first error value is less than the fourth threshold value, operations S430, S440, and S450 may be performed, The fourth threshold value is described above in detail in relation to FIG. 3, and thus a detailed description thereof will not be provided here.

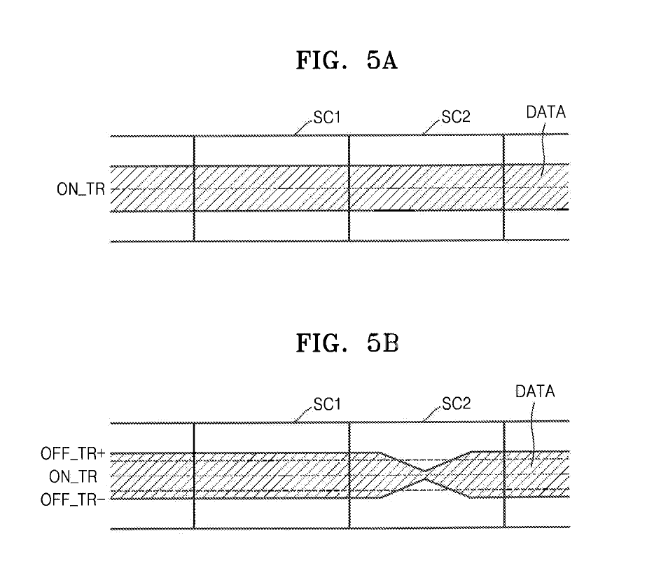

FIG. 5A is a diagram showing a state when data (DATA) is recorded on first and second sectors SC1 and SC2.

Referring to FIGS. 3, 4, and 5A, the data DATA is normally recorded on the first and second sectors SC1 and SC2, Accordingly, if a head 16 operating in an on-track state (OR_TR) performs a read operation on the first and second sectors SC1 and SC2, the number of error symbols in first data read from each of the first and second sectors SC1 and SC2 may be less than a first threshold value, and thus the first and second sectors SC1 and SC2 may be determined as normal sectors having no defect.

FIG. 5B is a diagram showing another state when data DATA is recorded on first and second sectors SC1 and SC2.

Referring to FIGS. 3, 4, and 5B, the data (DATA) is normally recorded on the first sector SC1, However, if the data (DATA) is not normally recorded on the second sector SC2. For example, the second sector SC2 illustrates an scenario where the head 16 may have been inadvertently positioned such that a full amount of data is not uniformly written to the second sector SC2. That is, the data (DATA) is written to the center of the second sector SC2; however, the data (DATA) is not written to regions adjacent the center of the second sector SC2. Consequently, if a head 16 in an on-track state ON JR performs a read operation on the first and second sectors SC1 and SC2, the number of error symbols in first data read from the first sector SC1 may be less than a first threshold value, and the number of error symbols in the first data read from the second sector SC2 may be equal to or greater than the first threshold value. Alternatively, the number of error symbols in the first data read from the second sector SC2 may be equal to or greater than the first threshold value, and may be less than a fourth threshold value.

In this case, operation S330 or S430 illustrated in FIG. 3 or 4 is performed on the second sector SC2 such that second data may be read from the second sector SC2 by off-tracking the head 16 in a positive direction into a positive off-track state (OFF_TR+), and third data may be read from the second sector SC2 by off-tracking the head 16 in a negative direction into a negative off-track state (OFF_TR−). That is, by operating the head 16 in the off-track state such that the head 16 is off-tracked in the positive off-track direction and the negative off-track direction, the controller 240 may detect that data does not exist in the off-track regions and may therefore determine that the second sector SC2 is defective. Subsequent operations are described above in detail in relation to FIGS, 3 and 4, and thus detailed descriptions thereof will not be provided here.

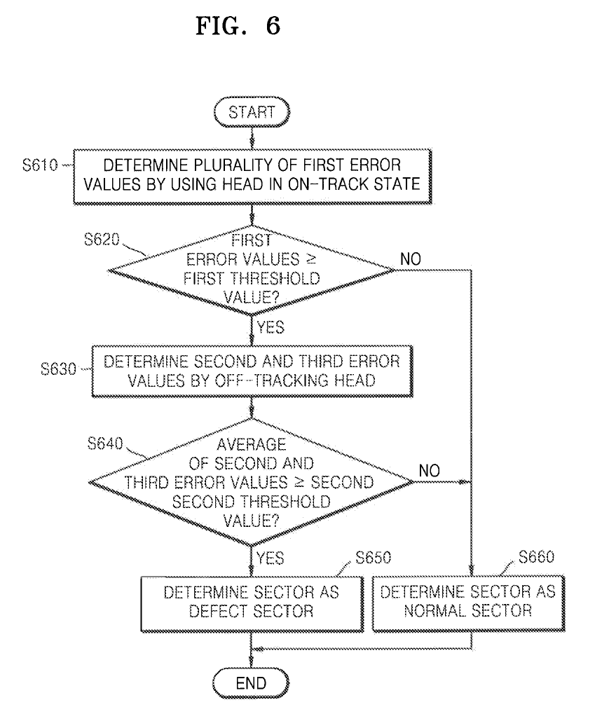

FIG. 6 is a flowchart of a method of detecting a defective sector, according to another exemplary embodiment of the general inventive concept.

Referring to FIG. 6, initially, a head 16 of a hard disk drive 100 may be controlled to be disposed at the center of a sector to detect a defect, on a disk 12 so as to be in an on-track state, Data may be repeatedly read from the sector when the head 16 operates in the on-track state. That is, unlike the method illustrated in FIG. 3, in the method illustrated in FIG. 6, the first data may be read from the sector a plurality of times while operating the head 16 in the on-track state. Like the method illustrated in FIG. 3, each portion of the read first data may include at least one error symbol, A plurality of first error values may be determined by the controller 240 by counting the number of error symbols in each piece of the read first data (operation S610).

The controller 240 may compare the first error values may to a first threshold value (operation S620). If at least one of the first error values is less than the first threshold value in operation S620, the controller 240 may determine the sector as a normal sector having no defect (operation S660), The first threshold value is described above in detail in relation to FIG. 3, and thus a detailed description thereof will not be provided here.

However, if the first error values are equal to or greater than the first threshold value in operation S620, second data may be read from the sector by off-tracking the head 16 in a positive direction, and third data may be read from the sector by off-tracking the head 16 in a negative direction. For example, the second data may be read from the sector by off-tracking the head 16 in the positive direction by 15%, and the third data may be read from the sector by off-tracking the head 16 in the negative direction by 15%. The read second data may include at least one error symbol, and the number of error symbols counted in the read second data may be determined as a second error value (operation S630). Also, the read third data may include at least one error symbol, and the controller 240 may count the number of error symbols in the read third data to determine a third error value (operation S630).

Alternatively, in operation S630, the second data may be repeatedly read from the sector by off-tracking the head 16 in the positive direction, and the third data may be repeatedly read from the sector by off-tracking the head 16 in the negative direction. Each portion of the read second data may include at least one error symbol, and the number of error symbols may be counted in each portion of the read second data. Accordingly, the controller 240 may calculate an average of the number of error symbols counted in the second data to determine the second error value (operation S630). Also, each portion of the read third data may include at least one error symbol, and the number of error symbols may be counted in each piece of the read third data. Accordingly, the controller 240 may calculate an average of the numbers of error symbols counted in the third data to determine the third error value (operation S630).

Operations S640, S650, and S660 are similar to operations S340, S350, and S360 illustrated in FIG. 3, and thus detailed descriptions thereof will not be provided here.

Although not illustrated in FIG. 6, like the method illustrated in FIG. 3, the method illustrated in FIG. 6 may further include comparing the first error values to a fourth threshold value, between operations S620 and S630. For example, if the controller 240 determines that the first error values are equal to or greater than the fourth threshold value, the method may directly proceed to operation S650 so as to determine the sector as a defective sector having a defect, without performing operations S630 and S640. If at least one of the first error values is equal to or greater than the first threshold value, and is less than the fourth threshold value, operations S630 and S640 may be performed such that the controller 240 may determine whether the sector has a defect. That is, if it may not be determined that the sector does not have a defect because at least one of the first error values is equal to or greater than the first threshold value, and if it may not be determined that the sector has a defect because at least one of the first error values is less than the fourth threshold value, operations S630 and S640 may be performed. The fourth threshold value is described above in detail in relation to FIG. 3, and thus a detailed description thereof will not be provided here.

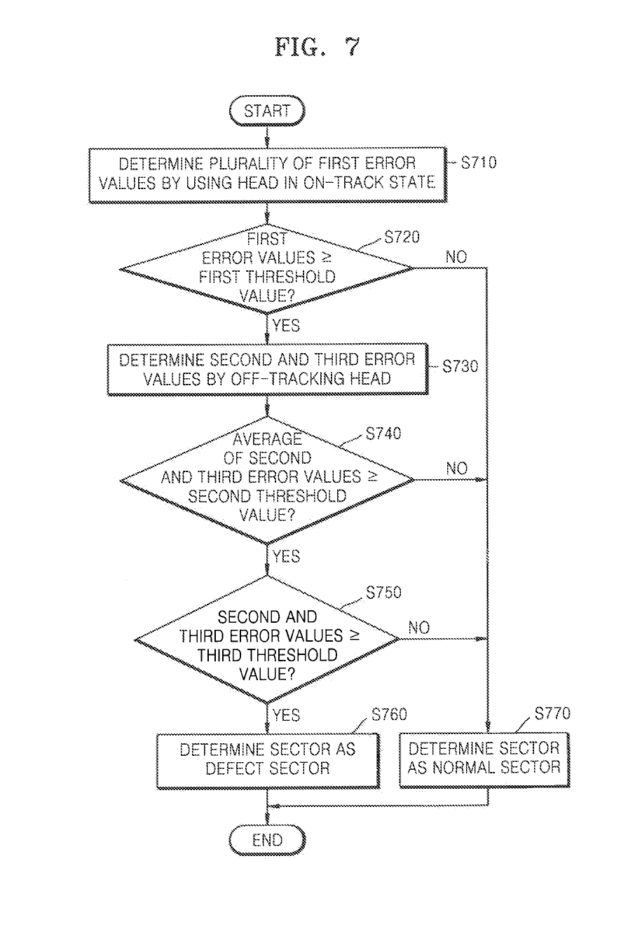

FIG. 7 is a flowchart of a method of detecting a defective sector, according to another exemplary embodiment of the general inventive concept,

Referring to FIG. 7, the head 16 may operate in an on-track state to repeatedly read first data from a sector to detect a defect. The read first data may include at least one error symbol, and the number of error symbols counted in the read first data may be determined as a first error value. That is, unlike the method illustrated in FIG. 4, in the method illustrated in FIG. 7, the first data may be read from the sector a plurality of times by using the head 16 while operating in the on-track state. Like the method illustrated in FIG. 3, each portion of the read first data may include at least one error symbol. A plurality of first error values may be determined by counting the number of error symbols in each portion of the read first data (operation S710).

The first error values may be compared, for example by the controller 240, to a first threshold value (operation S720). If at least one of the first error values is less than the first threshold value in operation S720, the sector may be determined as a normal sector having no defect (operation S770). The first threshold value is described above in detail in relation to FIG. 3, and thus a detailed description thereof will not be provided here.

If the first error values are equal to or greater than the first threshold value in operation S720, second data may be read from the sector by off-tracking the head 16 in a positive direction, and third data may be read from the sector by off-tracking the head 16 in a negative direction. The read second data may include at least one error symbol, and the number of error symbols counted in the read second data may be determined as a second error value (operation S730). Also, the read third data may include at least one error symbol, and the number of error symbols counted in the read third data may be determined as a third error value (operation S730).

Alternatively, in operation S730, the second data may be repeatedly read from the sector by off-tracking the head 16 in the positive direction, and the third data may be repeatedly read from the sector by off-tracking the head 16 in the negative direction. Each piece of the read second data may include at least one error symbol, and the number of error symbols may be counted in each piece of the read second data. An average of the numbers of error symbols counted in the second data may be determined as the second error value (operation S730). Also, each piece of the read third data may include at least one error symbol, and the number of error symbols may be counted in each piece of the read third data. An average of the number of error symbols counted in the third data may be determined as the third error value (operation S730).

Operations S740, S750, S760, and S770 are similar to operations S440, S450, S460, and S470 illustrated in FIG. 4, and thus detailed descriptions thereof will not be provided here.

Although not illustrated in FIG. 7, like the method illustrated in FIG. 4, the method illustrated in FIG. 7 may further include comparing the first error values to a fourth threshold value, between operations S720 and S730. In more detail, if the first error values are equal to or greater than the fourth threshold value, the method may directly proceed to operation S760 so as to determine the sector as a defective sector having a defect, without performing operations S730, S740, and S750. If at least one of the first error values is equal to or greater than the first threshold value, and is less than the fourth threshold value, operations S730, S740, and S750 may be performed to determine whether the sector has a defect. That is, if it may not be determined that the sector does not have a defect because at least one of the first error values is equal to or greater than the first threshold value, and if it may not be determined that the sector has a defect because at least one of the first error values is less than the fourth threshold value, operations S730, S740, and S750 may be performed. The fourth threshold value is described above in detail in relation to FIG. 3, and thus a detailed description thereof will not be provided here.

The general inventive concept has been particularly shown and described with reference to exemplary embodiments thereof. Terms used herein to describe the general inventive concept are for descriptive purposes only and are not intended to limit the scope of the general inventive concept. Accordingly, it will be understood by one of ordinary skill in the art that various changes in form and details may be made therein without departing from the spirit and scope of the following claims.

What is claimed is:

1. A method of detecting a defective sector, the method comprising:
determining a first error value by counting the number of error symbols in first data read from a sector by using a head in an on-track state;
reading second data from the sector by off-tracking the head in a positive direction, and reading third data from the sector by off-tracking the head in a negative direction, if the first error value is equal to or greater than a first threshold value;
determining a second error value based on the number of error symbols in the read second data;
determining a third error value based on the number of error symbols in the read third data; and
determining whether the sector has a defect, by comparing an average of the second and third error values to a second threshold value.

2. The method of claim 1, wherein the determining of whether the sector has a defect comprises determining that the sector has a defect, if the average of the second and third error values is equal to or greater than the second threshold value.

3. The method of claim 1, wherein the determining of whether the sector has a defect comprises:
comparing the second and third error values to a third threshold value, if the average of the second and third error values is equal to or greater than the second threshold value; and
determining that the sector has a defect, if the second and third error values are equal to or greater than the third threshold value.

4. The method of claim 1, further comprising:
determining that the sector does not have a defect, if the first error value is less than the first threshold value,

5. The method of claim 1, further comprising:
determining that the sector has a defect, without performing the reading of the second and third data, the determining of the second error value, the determining of the third error value, and the determining of whether the sector has a defect, if the first error value is equal to or greater than a fourth threshold value greater than the first threshold value,
wherein the reading of the second and third data comprises reading second data from the sector by off-tracking the head in the positive direction, and reading third data from the sector by off-tracking the head in the negative direction, if the first error value is equal to or greater than the first threshold value, and is less than the fourth threshold value.

6. The method of claim 5, wherein the reading of the second and third data comprises repeatedly reading second data from the sector by off-tracking the head in the positive direction, and repeatedly reading third data from the sector by off-tracking the head in the negative direction, if the first error value is equal to or greater than the first threshold value, and is less than the fourth threshold value.

7. The method of claim 6, wherein the determining of the second error value comprises:
counting the number of error symbols in each piece of the second data; and
determining an average of the numbers of error symbols counted in the second data, as the second error value, and
wherein the determining of the third error value comprises:
counting the number of error symbols in each piece of the third data; and
determining an average of the numbers of error symbols counted in the third data, as the third error value.

8. The method of claim 1, wherein the reading of the second and third data comprises repeatedly reading second data from the sector by off-tracking the head in the positive direction, and repeatedly reading third data from the sector by off-tracking the head in the negative direction, if the first error value is equal to or greater than the first threshold value,

9. The method of claim 8, wherein the determining of the second error value comprises:
counting the number of error symbols in each piece of the second data; and
determining an average of the numbers of error symbols counted in the second data, as the second error value, and
wherein the determining of the third error value comprises:
counting the number of error symbols in each piece of the third data; and
determining an average of the numbers of error symbols counted in the third data, as the third error value.

10. The method of claim 1, further comprising determining the first through third threshold values according to a bit error rate.

11. A method of detecting a defective sector, the method comprising:
repeatedly reading first data from a sector by using a head in an on-track state;
determining a plurality of first error values by counting the number of error symbols in each piece of the read first data;
reading second data from the sector by off-tracking the head in a positive direction, and reading third data from the sector by off-tracking the head in a negative direction, if the plurality of first error values are equal to or greater than a first threshold value;
determining a second error value based on the number of error symbols in the read second data;
determining a third error value based on the number of error symbols in the read third data; and
determining whether the sector has a defect, by comparing an average of the second and third error values to a second threshold value.

12. The method of claim 11, wherein the determining of whether the sector has a defect comprises determining that the sector has a defect, if the average of the second and third error values is equal to or greater than the second threshold value

13. The method of claim 11, wherein the determining of whether the sector has a defect comprises:
comparing the second and third error values to a third threshold value, if the average of the second and third error values is equal to or greater than the second threshold value; and
determining that the sector has a defect, if the second and third error values are equal to or greater than the third threshold value.

14. The method of claim 11, further comprising:
determining that the sector does not have a defect, if at least one of the plurality of first error values is less than the first threshold value,

15. The method of claim 11, further comprising:
determining that the sector has a defect, without performing the reading of the second and third data, the determining of the second error value, the determining of the third error value, and the determining of whether the sector has a defect, if the plurality of first error values are equal to or greater than a fourth threshold value greater than the first threshold value,
wherein the reading of the second and third data comprises reading second data from the sector by off-tracking the head in the positive direction, and reading third data from the sector by off-tracking the head in the negative direction, if the plurality of first error values are equal to or greater than the first threshold value, and are less than the fourth threshold value,

16. The method of claim 15, wherein the reading of the second and third data comprises repeatedly reading second data from the sector by off-tracking the head in the positive direction, and repeatedly reading third data from the sector by off-tracking the head in the negative direction, if the plurality of first error values are equal to or greater than the first threshold value, and are less than the fourth threshold value.

17. The method of claim 16, wherein the determining of the second error value comprises:
counting the number of error symbols in each piece of the second data; and
determining an average of the numbers of error symbols counted in the second data, as the second error value, and
wherein the determining of the third error value comprises:
counting the number of error symbols in each piece of the third data; and
determining an average of the numbers of error symbols counted in the third data, as the third error value.

18. The method of claim 11, wherein the reading of the second and third data comprises repeatedly reading second data from the sector by off-tracking the head in the positive direction, and repeatedly reading third data from the sector by off-tracking the head in the negative direction, if the plurality of first error values are equal to or greater than the first threshold value,

19. The method of claim 18, wherein the determining of the second error value comprises:
counting the number of error symbols in each piece of the second data; and
determining an average of the numbers of error symbols counted in the second data, as the second error value, and
wherein the determining of the third error value comprises:
counting the number of error symbols in each piece of the third data; and
determining an average of the numbers of error symbols counted in the third data, as the third error value.

20. The method of claim 11, further comprising:
determining the first through third threshold values according to a bit error rate.
